(19) United States
(12) Patent Application Publication
(10) Pub. No.: US 2011/0167403 A1
(43) Pub. Date: Jul. 7, 2011

(54) METHODS FOR PLATFORM-AGNOSTIC DEFINITIONS AND IMPLEMENTATIONS OF APPLICATIONS

(76) Inventors: Jason Townes French, Sunnyvale, CA (US); Auston John Stewart, Hilo, HI (US)

(21) Appl. No.: 12/961,480

(22) Filed: Dec. 6, 2010

Related U.S. Application Data
(60) Provisional application No. 61/266,830, filed on Dec. 4, 2009.

(51) Int. Cl. G06F 9/44

(52) U.S. Cl. 717/105; 717/109

(57) ABSTRACT

A system and method are provided for enabling platform-agnostic definition and implementation of web and native applications. Preferred embodiments of the invention provide an Application Markup Language for the definition of interfaces and control logic. Preferred embodiments of the invention do not specifically call for explicit pixel dimensions for relative sizing and position terms allowing the creation of applications in familiar terms providing for web browser or native application environment to render them appropriately for the platform. The embodiments eliminate the need to make multiple applications and rather provide for a single version executed through a runtime implementing embodiments of the invention homogeneously and uniformly for all target platforms.

### CROSS-REFERENCE TO RELATED APPLICATIONS

The present application claims priority from U.S. Provisional Application Ser. No. 61/266,830 filed Dec. 4, 2009, which is incorporated herein by reference in its entirety for all purposes.

### FIELD

The present invention relates generally to network-enabled applications, and more particularly to methods for enabling platform-agnostic definition and implementation of applications for native development platforms.

### BACKGROUND

To provide convenience and to reach a broad audience, most conventional Internet-based applications use HTML and JavaScript and JavaScript-compatible languages such as ECMAScript to render content via web browsers on devices such as desktop computers, laptops and smartphones. However, even within HTML, problems exist because HTML is not handled consistently across browsers, resulting in a fragmented user experience and developer experience. A further problem exists in that HTML was designed for page-like, stateless documents rather than for modern applications that make full use of device display, memory and input capabilities to deliver highly dynamic behavior. Meanwhile, it is a goal to provide network-enabled applications in the native application paradigm seamlessly to all devices capable of accessing the Internet, whether through a web-based or platform-native presentation. For instance, it is desirable for users to be able to access their Internet-based applications as actual, native applications on their desired devices, such as native iPhone apps on their iPhones, or as web applications in Internet Explorer (or another web browser) through a public Internet terminal. One way to achieve this goal is to create separate applications for the web and native platforms that make use of the same network or Internet data source. This method however, is costly and complex, as it requires the developer to maintain two or more different codebases which may share little, if any, common code.

Historically, the issue of cross-platform software has plagued computer science. Since the introduction of the personal computer, millions of programs have been written, each for a particular computer architecture. This has the unfortunate side-effect of making the lifespan of the program no longer than lifespan of the architecture on which it was designed to run.

For example, if a computer hardware engineer develops a new computer architecture/platform and introduces it to the market, he must also now solve the problem of providing the programs customers are accustomed to using on this new architecture.

In response, virtualization strategies for computer architectures that enabled software to run in more places were created.

Java is such an example. Any computer that can run a compatible version of the Java Virtual Machine can run a program that was compiled in the Java programming language. Further, Swing, a cross-platform user interface library, enables the creation of cross-platform graphical applications. With the combination of Java and the Swing library, GUI apps can be created that run on Macs and PCs without changing the code.

However, computer architecture has continued evolving, and the landscape of consumer computing has changed.

In addition to traditional desktop and laptop computing devices, consumers now rely heavily on robust portable personal computing devices such as PDAs netbooks, and smartphones.

When attempting to run software on these new types of mobile device, developers encountered computer architecture problems (e.g. ARM processors vs. x86), which were ultimately solved by providing Java running on mobile architectures.

The wide majority of graphical Java applications depend on Swing for their implementation. With Swing, the developer specifies windows, menus, and buttons with which the application would be adorned. There remains however, a problem with getting this to work cross-platform—even if a mobile JVM could interpret the bytecode representing a compiled Java application, a “window” on a desktop computer means something very different from a “window” on a phone.

In order to address these problems, the Java Platform Micro Edition (J2ME)—a completely separate runtime environment and Software Development Kit (SDK) was introduced to support the development of mobile-based Java apps. This enabled Java developers to write programs for mobile devices, but it did nothing to help Java applications that had already been written for the desktop run on mobile devices. Instead, this fragmented the Java application market, creating multiple breeds of Java applications—J2SE (Java 2 Standard Edition) (desktop applications) and J2ME (Java 2 Micro Edition) (mobile applications).

The Flash platform took a slightly more unified approach to cross-platform development, pushing for the same Flash programs to run on all Flash players—mobile or otherwise. In addition, Flex was introduced. Flex is a programming environment which allows developers to write their code in MXML and ActionScript—very similar to what an XKernel developer does with AML and XScript—and then compiles it to a .swf which can be run anywhere that has a Flash player.

While the Flash/Flex solution addressed a way to deliver a single program across several architectures, most of the previous Flash apps were written with the assumption of being used in a web browser, or at least on a large screen. However, mobile or portable devices do not have large screens, and as a result, the realities of computing on these smaller displays created problems. One issue in particular is that the size of a pixel is not standardized and is dependent on the resolution of the device. Embodiments of the present invention provide novel platform-agnostic definition and implementation of network-enabled applications.

### SUMMARY OF PREFERRED EMBODIMENTS OF THE INVENTION

Preferred embodiments of the present invention relate generally to web and native applications, and more particularly to methods for enabling platform-agnostic definition and implementation of web and native applications. Preferred embodiments of the invention provide an Application Markup Language (AML) for the definition of interfaces and control logic, the latter embedded using a high-level, meta-programming language. As in HTML, tags are used to define the structural elements of the application. However, rather than referencing simple and mostly visual page layout-oriented document terms such as “paragraph”, the tags are taken to represent complex objects with associated attributes and behaviors. Preferred embodiments of the invention do not specifically call for explicit pixel dimensions for relative sizing and position terms such as “tall” and “wide” allowing the creation of applications in familiar terms providing for web browser or native application environment to render them in the way that makes most sense for the platform. The embodiments eliminate the need to make multiple applications, such as an iPhone version, a desktop/laptop version, and a BlackBerry version, and rather provide for a single version executed through a runtime implementing embodiments of the invention homogeneously and uniformly for all target platforms.

Preferred embodiments of the invention relieve applications from being tied to a particular rendering context. For example, applications defined in terms of HTML will always be dependent on the specifics of a given web browser in order to function as intended, whereas applications defined in terms of visual and logical constituents according to the novel methods present in the embodiments can be interpreted in any application execution environment. The embodiments provide for cross-platform capabilities, while also accelerating web application development by eliminating the need for browser-specific custom code.

Further, preferred embodiments of the present invention remove specific reference to pixel values from the programming language.

Other and further features and advantages of the preferred embodiments present invention will be apparent from the following descriptions of the various embodiments. It will be understood by one of ordinary skill in the art that the following embodiments are provided for illustrative and exemplary purposes only, and that numerous combinations and modification of the elements of the various embodiments of the present invention are possible.

### BRIEF DESCRIPTION OF THE DRAWINGS

These and other aspects and features of the preferred embodiments of the present invention will become apparent to those ordinarily skilled in the art upon review of the following description of specific embodiments of the invention in conjunction with the accompanying figures, wherein:

FIGS. 1 to 3 are block diagrams illustrating implementations of embodiments of the invention;

FIG. 4 is an example of AML user interface code for a model application;

FIG. 5 is an example of a desktop user interface as might be shown for the AML example of FIG. 4;

FIGS. 6A and 6B are an example of a smartphone user interface as might be implemented in accordance with an embodiment of FIG. 4; and

FIG. 7 depicts a process for a method for enabling platform agnostic platforms in accordance with an embodiment of the present invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the embodiments of the present invention will be described, and detailed descriptions of other portions of such known components will be omitted so as not to obscure the embodiments. Embodiments described as being implemented in software are not limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope of the embodiments of the present invention encompasses present and future known equivalents to the known components referred to herein by way of illustration.

According to some aspects, the embodiments of the invention provide an Application Markup Language (AML) for example, that is an XML 1.0-compliant document format. The methodology of defining and implementing applications using AML allows for the platform-agnostic definition of applications. The embodiments described herein are not intended to be limiting and are provided for exemplary purposes only. For ease of understanding, the embodiments are provided using XML, and the particular interface definitions provided below. Rather, other implementations are possible.

Abstract Interface Definition in XML

As described herein, application interfaces are defined in an XML hierarchy using abstract components. Interface elements contained within other elements in the XML hierarchy are interpreted as being visually contained by their parents. The following are examples of abstract interface components and their usage:

Canvas—The canvas tag is used to encapsulate all graphical elements defined for an application in an AML document. This separates interface content from logic, which is encapsulated in xscript tags.

Ex:

<xdk:canvas>
. . .
</xdk:canvas>

Window—The window tag defines an application window with a title bar and close button. Applications may have multiple windows, some or all of which may be hidden on launch. Each window has a single root Layout which holds all of its'interface components.

Ex:

<appkit:window title = “XConnect”>
. . .
</appkit:window>

Layout—An invisible, structural component that contains and organizes other components. When representing a grid-based layout, rows and columns are used to indicate nested components' positions within the structure.

Ex:

```
<xui:layout width = “wide” height = “tall”>
  <xui:row>
    <xui:column>
      . . .
    </xui:column>
    <xui:column>
      . . .
    </xui:column>
  </xui:row>
</xui:layout>
```

Image Button—An interactive interface component identified by an icon and/or label. The developer may provide the name of a method, defined in the logic definition section later in the XML document, which should be invoked when the button is pressed.

Ex:

<appkit:imagebutton image = “images/xconnect/messages.png”
label=“Messages” method=“launchMessages” />

Platform-Agnostic Logic Definition in XScript

The novel AML described herein allows for definition of program logic in an object-oriented, high-level programming language termed XScript. Each supported platform's AML runtime utilizes a rewriter as well as proprietary and open-source libraries to convert the XScript into code that can be interpreted by that platform's preferred scripting language for execution, as opposed to direct execution on a virtual machine, or through an interpreter. For instance, the AML Web Runtime rewrites XScript as JavaScript extended by the open-source Prototype library (see, e.g., http://www.prototypejs.org/) to support the language-level object constructs that XScript provides. This allows a developer to write a single version of the control logic for their AML application that will run on any supported platform. Also, because XScript is a high-level language absent of all low-level, machine-dependent behaviors and functionality, interpreters need only to support its semantics and can do so with a rewriter, rather than with a complex virtual machine. XScript is thus an abstraction above JavaScript, and can be syntactically and semantically similar to JavaScript, or can be a different language. Even when XScript is chosen to be similar to JavaScript, certain classes and methods, such as the date class, the image class, the document object, getelementbyid, and the window object are prohibited, as their use creates compatibility problems. The prohibition against use of such classes and methods can be automated and enforced, as can be the use of only certain classes and methods.

Ex:

```
  <xdk:script><! [CDATA[
  {
  launchContacts: function( ) {
  var contactsWindow =
this.canvas.getWindowByName(‘Contacts’);
  contactsWindow.show( );
  contactsWindow.window_obj.setAjaxContent(‘xbp/network/contac
tChooser’);
  },
  launchDirectory: function( ) {
  var directoryWindow =
this.canvas.getWindowByName(‘Directory’);
  directoryWindow.show( );
  directoryWindow.window_obj.setAjaxContent(‘xbp/network/organ
izationChooser’);
  }}
  ]]>
  </xdk:script>
```

Relative Semantics for Interface Layouts Enabling Device Specific Display and Interaction

Although some options are provided to allow customization of certain aspects of the abstract components selected by the developer, the exact pixel renderings of the components and interface mechanics are purposefully omitted to allow each target platform's AML interpreter to provide optimal results on devices with varying display and input capabilities. AML is more general than HTML, more consistent, and furthermore, makes resolution-independent definition of user interfaces possible, which is not achievable with HTML. HTML depends on height and width in pixels, or on relative container sizes; for example, an element is specified either as 10 pixels wide, or as 10 percent of the width of its container. With AML, rather than specifying exact pixel widths and heights, developers set the width and height of container elements to relative proportions (e.g. tall or short, wide or thin). When the application is run, during window rendering, a recursive traversal of interface elements, starting at the root Layout, is performed to determine dynamically the exact pixel dimensions of the elements. Element pixel dimensions may be determined by querying the element itself, asking the element for its preferred height and width for its dimension class (e.g. short, wide, tall) and the resolution of the client device. For example, during the recursive traversal of interface elements a tag such as the following may be encountered:

<appkit:button width=“wide”>

In response, the rendering system queries the AppKit's definition of a button, asking for the amount of pixels that it considers to be “wide” for a client resolution space of X pixels wide by Y pixels high (where X and Y are the dimensions of the total screen space). The AppKit library then returns to the rendering library a discrete pixel value which is placed in the code. While this is a precise pixel value, it is not provided by the developer/engineer, but rather by the API of the UI toolkit.

In one embodiment, a novel dynamic computation of layout occurs which is not performed through scaling (uniformly growing or shrinking) the dimensions of the pixels. For example, if a button is 100 pixels wide on a screen that is 800 pixels wide by 600 pixels high, that same button on a screen that is 400 pixels wide by 300 pixels high is not necessarily going to be 50 pixels (half the original height). Instead, layout determination is done through a piece-wise function f(w, h) where w is the width of the client screen in pixels and h is the height of the client screen in pixels. Intervals are then defined on w and h for each of the supported client screen resolution spaces. Generally speaking, thus, this novel approach improves the adaption of user interfaces to a variety of screens by not simply using the conventional method of scaling, which may still create distortions but rather by using pre-determined values which are optimal for the target client display. Because developers do not explicitly define pixel values when specifying the elements in applications, the application runtime environment can choose what is best for that particular type of environment. To ensure that all elements are rendered legibly on the target platform, those embedded in containers specifying a ‘short’ or ‘thin’ size report their device-specific minimum heights and widths, respectively. These are totaled to determine the remaining horizontal and vertical pixels that may be provisioned to elements in ‘wide’ and ‘tall’ containers equally, proportionally, based on their depth in the Layout hierarchy, or with consideration for those elements' device-specific preferred or natural sizes. The AML interpreter, which is dynamically loaded onto each client, is responsible for interpreting the AML correctly in the current context, and is aware of the platform characteristics of the platform it is running on. This enables a single developer-defined layout to be rendered as legibly and attractively on a smart phone as on an HD display for true cross-platform functionality.

Ex:

```
  <xui:layout width = “thin” height = “tall”>
    <xui:column>
        <xui:row>
          <appkit:imagebutton image =
“images/xconnect/messages.png” label=“Messages”
method=“launchMessages” />
        </xui:row>
      <xui:row>
          <appkit:imagebutton image =
“images/xconnect/contacts.png” label= “Contacts”
method=“launchContacts” />
        </xui:row>
        <xui:row>
          <appkit:imagebutton image =
“images/xconnect/directory.png” label=“Directory” method=“
launchDirectory” />
        </xui:row>
        <xui:row>
          <appkit:imagebutton image =
“images/xconnect/directory.png” label=“New Thing”
method=“launchDirectory” />
        </xui:row>
    </xui:column>
  </xui:layout>
```

Extensibility Through Implied Library Reference

In embodiments, XML namespace declarations at the beginning of an AML document are interpreted by XDK/AML runtimes to be library references. Before the application is launched, these libraries, which make available new objects and functions, are loaded dynamically from the server, making them function effectively as include statements. This is done by defining the appropriate xmlns (XML namespace) attributes, which causes the client to ask the server for the XML namespace definition, which is used here in a novel way, to also load the appropriate specific XScript/JavaScript library implementations.

Ex:

<xdk:aml xmlns:xdk=“http://www.xpertfinancial.com/xdk/”
xmlns.xui=http://www.xpertfinancial.com/xdk/xui/
xmlns:appkit=“http://www.xpertfinancial.com/xdk/appkit/”>

This permits the dynamically loaded libraries to be selected or even themselves be dynamically generated on demand based on various parameters of the request to load the libraries. For example, a library can be selected from an existing inventory of available libraries or dynamically generated based upon the platform on which AML is running, upon the browser in use by the user, etc.

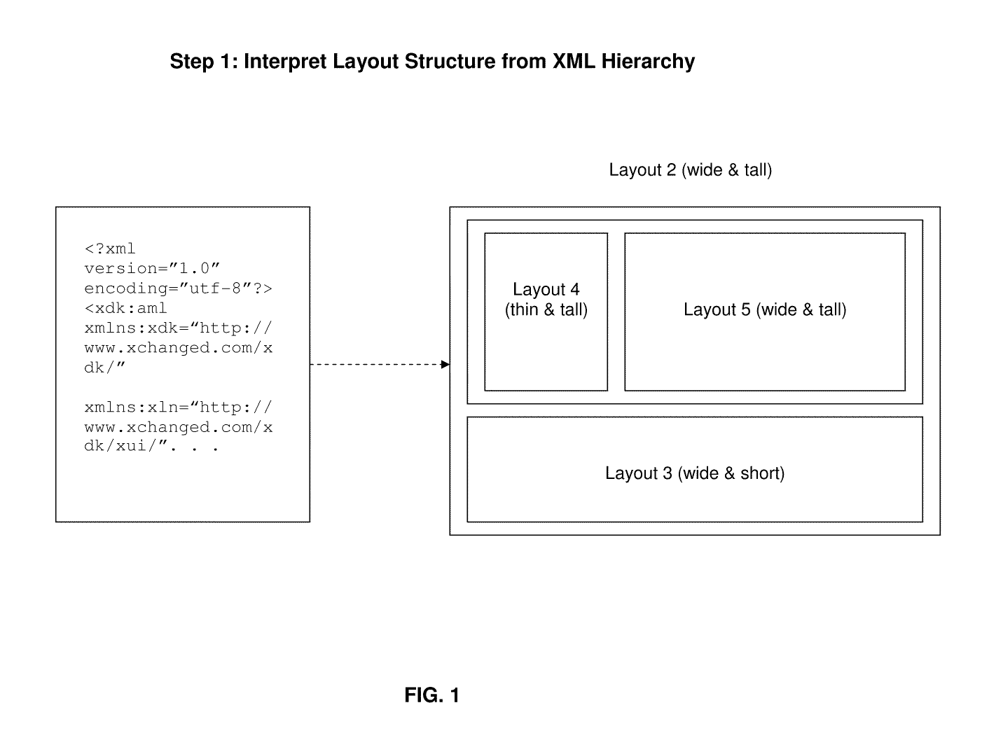

FIGS. 1 to 3 further illustrate example implementation aspects of embodiments of the present invention.

FIG. 1 illustrates a first step, which is to interpret layout structure from an XML hierarchy. For example, as shown in FIG. 1, an AML document in XML 1.0 format is parsed and its containment hierarchy traversed to discover two layouts (Layout 2 and Layout 3) within the root layout (Layout 1), the first of which contains a further two layouts (Layout 4 and Layout 5).

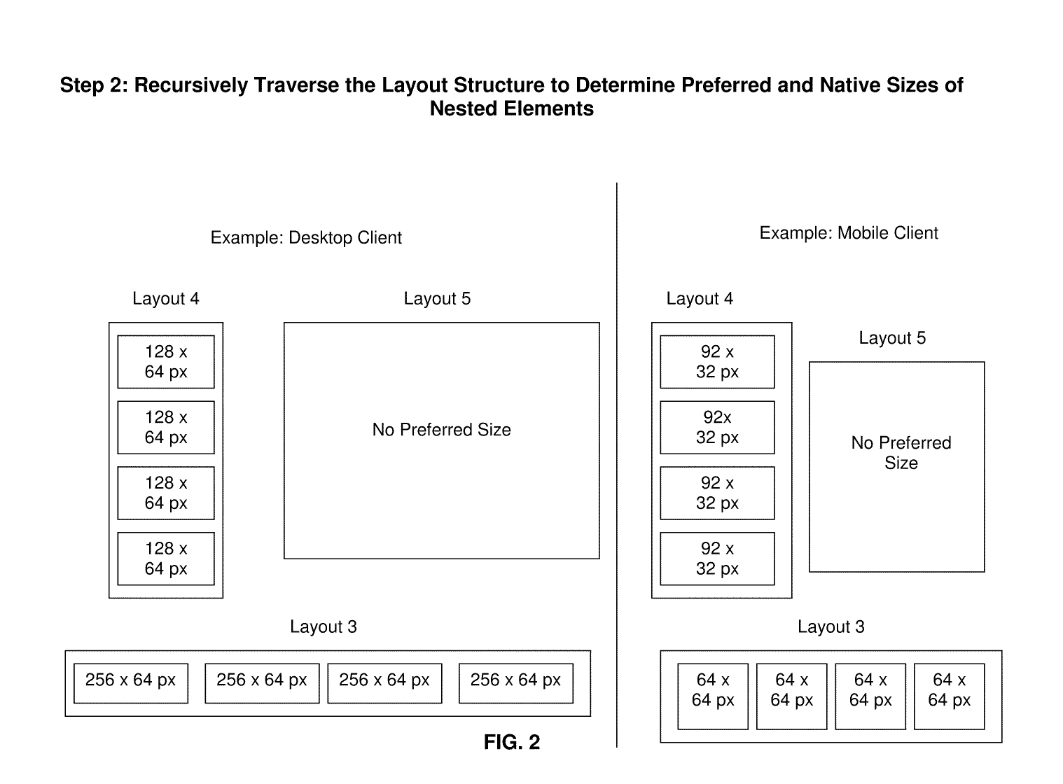

FIG. 2 illustrates a second step, which is to recursively traverse the layout structure to determine preferred and native sizes of nested elements. In FIG. 2, the same layout structure is traversed by AML interpreters on a desktop computer and a mobile device. On the desktop, the interpreter finds non-layout elements in Layout 4 natively sized at 128×64 pixels and others in Layout 3 that are natively sized at 256×64 pixels. On the mobile device, these non-layout elements have different graphical representations and report native sizes of 96×32 pixels and 64×64 pixels, respectively. On both devices the non-layout element in Layout 5 reports no native or preferred size.

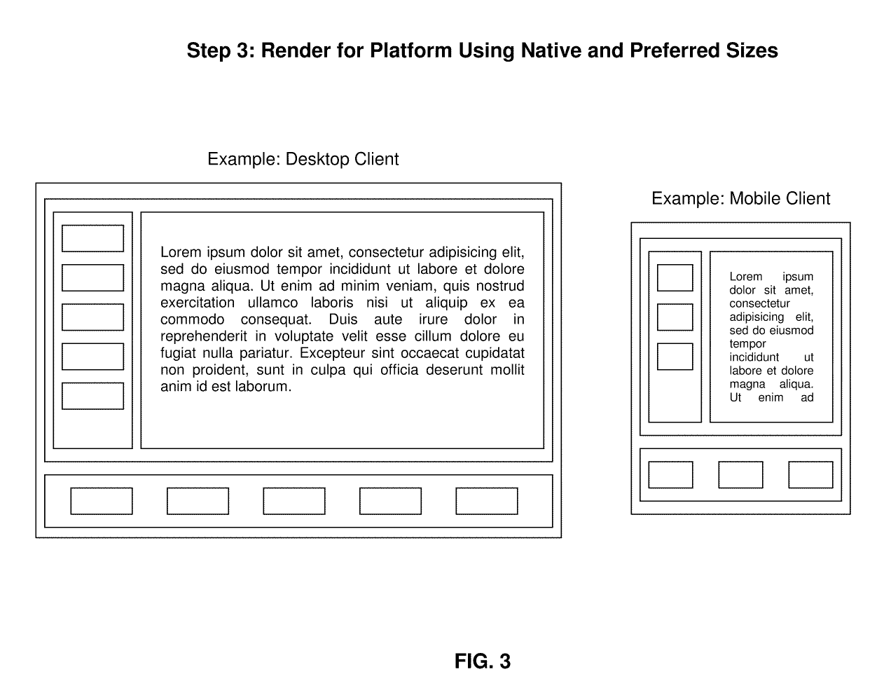

FIG. 3 illustrates a third step, which is to render for a platform using native and preferred sizes. In FIG. 3, the layouts and elements within the layout structure are composited using the both determined native and preferred sizes and layout parameters on a desktop computer and mobile device. As Layout 3 is defined as ‘wide’ and ‘short’, its height is set to be the native height of the tallest non-layout element embedded within it (64 pixels on both the desktop and mobile clients) and its width, because there are no other horizontally positioned elements at its level in the layout hierarchy, is taken to be the width of the parent layout (which in this case is the width of the containing window). As Layout 2 is defined as ‘wide’ and ‘tall’ and only 64 pixels of vertical resolution has been claimed by Layout 3, Layout 2's width will be that of its parent and its height that of its parent minus the 64 pixels occupied by Layout 3. As Layout 4 is defined as ‘thin’ and ‘tall’, its width is constrained to the native width of the widest element it contains (256 pixels on the desktop and 92 pixels on the mobile device) and its height, as there are no other vertically positioned elements at its level in the layout hierarchy, is taken to be the height of its parent layout, Layout 2. As the non-layout element embedded in Layout 5 reports no preferred or native size on either device but Layout 5 is defined as both ‘wide’ and ‘tall’, both devices allocate the remaining horizontal and vertical pixels in Layout 2 to Layout 5 and its contents. Now that concrete pixel values have been assigned to each layout and non-layout element on each device, their embedded elements may elect to scale from a native size to an alternative preferred size if interstitial space exists. In this example, it is assumed that elements have no preferred sizes apart from their native sizes on either device. The final renderings on the desktop computer and mobile device, as shown in FIG. 3, have the Same visual structure, but are differently proportioned to facilitate interface legibility, functionality and familiarity on both platforms.

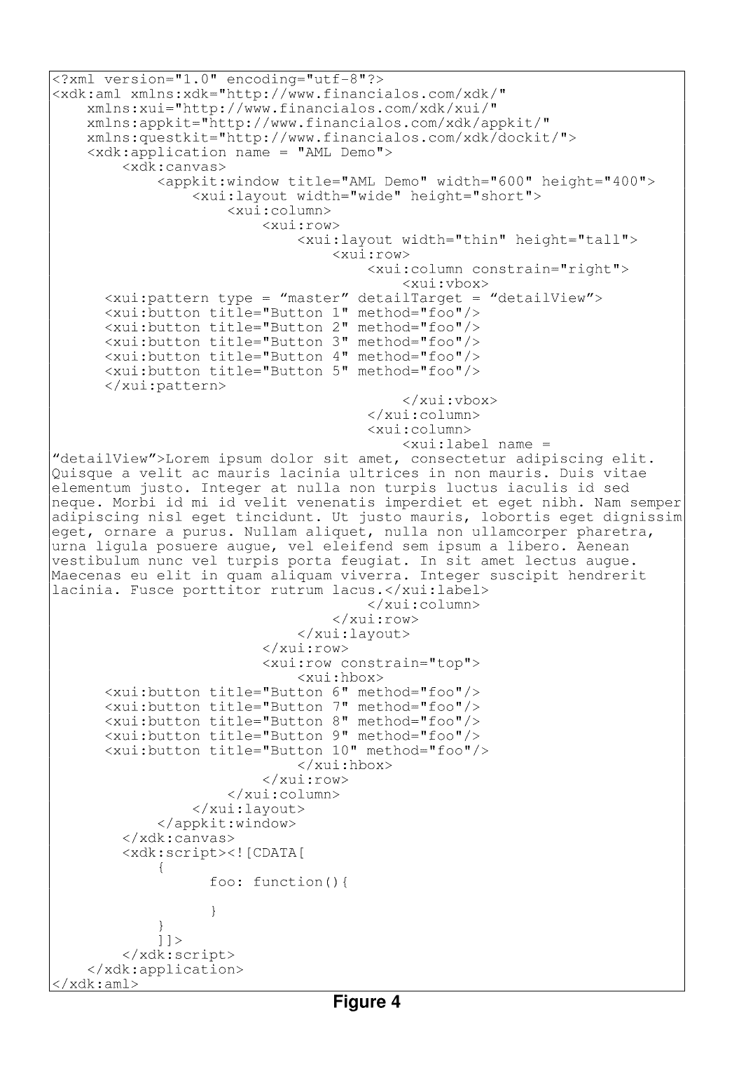

FIGS. 4 to 6 further illustrate example implementation aspects of the present invention. The AML code depicts each user interface element, and also defines what XScript a given element is linked to. For example, “Button 1” is shown linked to XScript method “foo”.

FIG. 4 illustrates an example of AML user interface code for a model application. For example, the button definitions cause the appropriate buttons to be created and presented to the user. Their exact placement and size will depend on what platform the application is running on. Absent the use of the novel AML user interface code, the server would be would need to have complex coding to provide customized device specific mappings of the intended user interface.

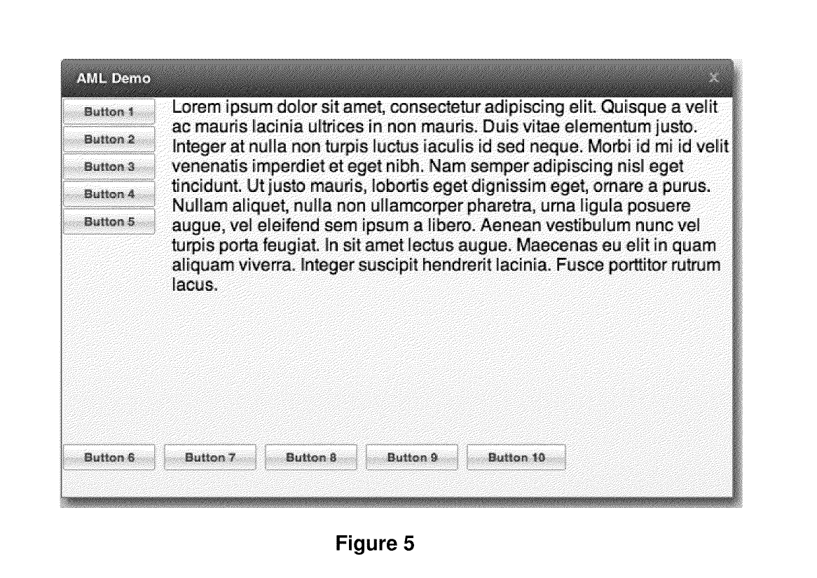

FIG. 5 illustrates an example of a desktop user interface as might be shown for the AML example of FIG. 4. Note that the size and placement of the buttons and other user interface elements is determined at run-time, by the AML interpreter, based on context.

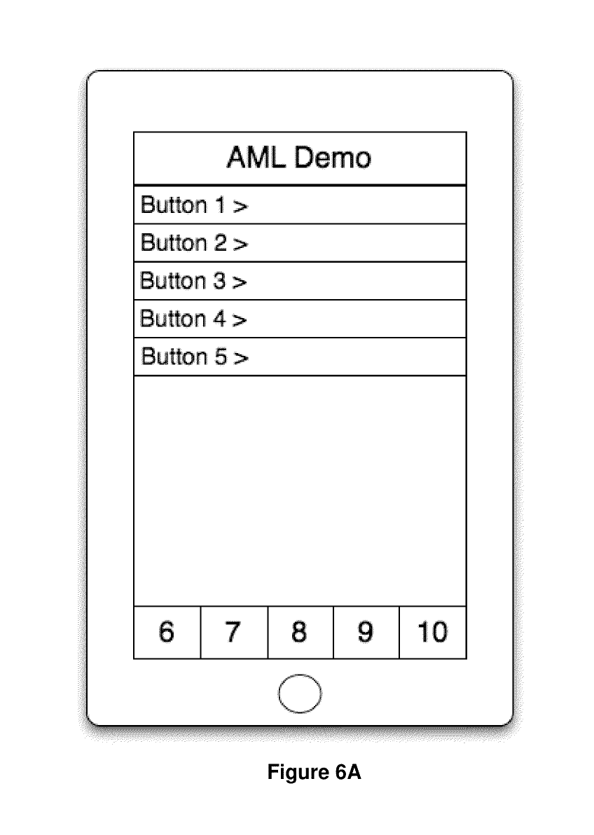

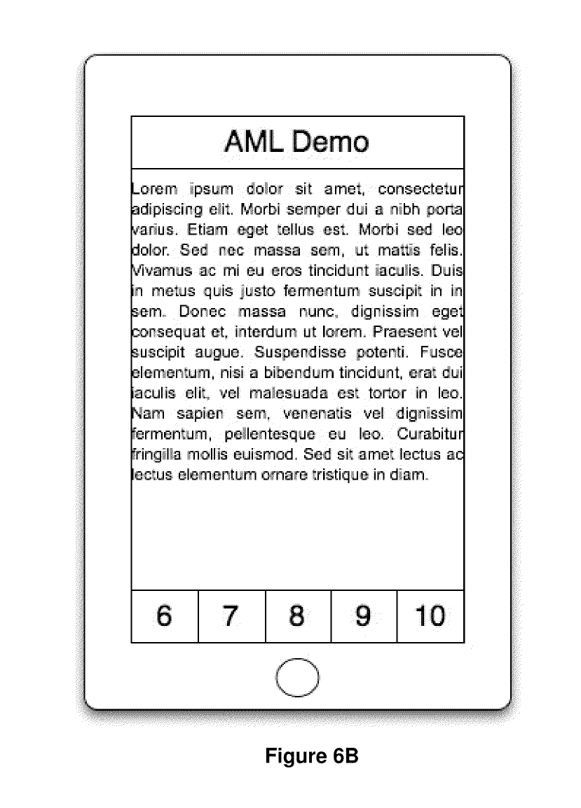

FIG. 6 illustrates an example of a smartphone user interface as might be shown for the AML example of FIG. 4. 6A depicts the initial user interface pane shown to a user on a smartphone. FIG. 6B shows an alternate pane that a user may navigate to from the initial pane. Note that the size and placement of the buttons and other user interface elements is determined at run-time, by the AML interpreter, based on context. The runtime determines the context through the use of a choice described in the AML for the application, which specifies which screen pattern applies, and by wrapping elements in tags which then, when appropriate, imply the transitions. The AML runtime processes the elements, looking for instances where the developer is referencing a screen pattern. In one embodiment, the developer, references a screen pattern by using the <xui:pattern> tag, and then wrapping other elements within that tag. When the AML runtime encounters this, it applies a set of pre-defined styles/sizes to all of the elements contained therein, and then also establishes the behaviors as implied by the specific screen pattern. A behavior in this case can be as simple as a pattern-specific callback function that gets called whenever the user interacts with an element within the screen pattern. In an non-limiting example, a developer may write the following code snippet:

| <xui:layout width=“thin” height=“tall”> | |
|---|---|
| | <xui:row> |
| | <xui:column |
| constrain=“right”> | |
| | <xui:vbox> |
| | <xui:pattern type = |
| “master” detailTarget = “detailView”> | |
| | <xui:button |
| title=“Button 1” method=“foo”/> | |
| | <xui:button |
| title=“Button 2” method=“foo”/> | |
| | <xui:button |
| title=“Button 3” method=“foo”/> | |
| | <xui:button |
| title=“Button 4” method=“foo”/> | |
| | <xui:button |
| title=“Button 5” method=“foo”/> | |
| </xui:pattern> | |
| | </xui:vbox> |
| | </xui:column> |
| | <xui:column> |
| | <xui:label name = |
| “detailView”>Lorem ipsum dolor sit amet, consectetur adipiscing | |
| elit. Quisque a velit ac mauris lacinia ultrices in non mauris. | |
| Duis vitae elementum justo. Integer at nulla non turpis luctus | |
| iaculis id sed neque. Morbi id mi id velit venenatis imperdiet et | |
| eget nibh. Nam semper adipiscing nisl eget tincidunt. Ut justo | |
| mauris, lobortis eget dignissim eget, ornare a purus. Nullam | |
| aliquet, nulla non ullamcorper pharetra, urna ligula posuere | |
| augue, vel eleifend sem ipsum a libero. Aenean vestibulum nunc | |
| vel turpis porta feugiat. In sit amet lectus augue. Maecenas eu | |
| elit in quam aliquam viverra. Integer suscipit hendrerit lacinia. | |
| Fusce porttitor rutrum lacus.</xui:label> | |
| | </xui:column> |
| | </xui:row> |
| | </xui:layout> |

The buttons that are labeled “Button 1” through “Button 5” are wrapped within a <xui:pattern> tag. The <xui:pattern> tag is additionally defining that it is of type “master”, and that it has specified its detail target as an element with the name of “detailView” (which happens to be the <xui:label> tag in the other column. Due to the fact that the <xui:button> tags are within the <xui:pattern> tag, the <xui:pattern> applies its behaviors to each of the elements. In this case, the tag informs the system that each of the buttons are “masters” of the details which show up in the element known as “detailView”. Because the rendering system now knows that these two sets of elements are intrinsically linked, each client type can decide how they wish to display this intrinsic relationship visually and interactively. For example, when clicking a master button in a smartphone version of the app, the runtime would check to see how devices of type “smartphone” visualize this relationship (e.g. the screen “slides” from the master over to the detail), and performs accordingly.

Where multiple sections are needed, as for example, in a smartphone user interface, examples of screen patterns include: master-detail, column browse, search/results, filter dataset, and palette/canvas. Note that FIGS. 6a and 6b work together to present the same information in the smartphone user interface as would be shown in corresponding FIG. 5 on a desktop device. Navigation from one screen to the next in the smartphone user interface is done by tapping any of the vertically stacked buttons. This causes the views to transition.

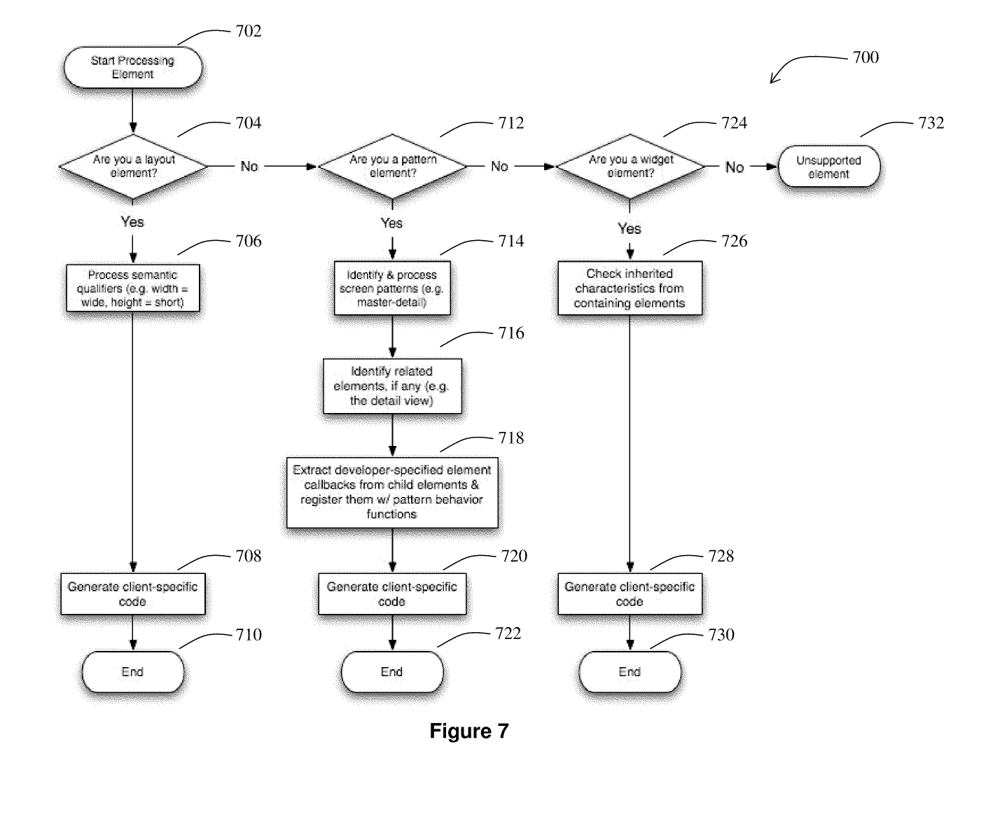

FIG. 7 illustrates one embodiment of a process for method 700 for enabling platform agnostic applications. The process begins with the processing of an element 702 and determining the element type. If the element is a layout element 704, the semantic qualifiers are processed 706, and the client specific code is generated 708 for the display 710. If the element is not a layout element, then the process proceeds to identify if the element is of another type. For example, if the element is a pattern element 712. If the element is a pattern element 712, the screen patterns are identified and processed 714. Once processed, related elements are identified 716, if such exist and developer-specified elements are extracted and registered with pattern behavior functions 718. The client specific code is generated 720 for the display 722. In another instance, the element is a widget element 724. If a widget element 724 is identified, the inherited characteristics from containing elements are checked 726, this checking is performed so that the existing characteristics can be implemented, optionally these characteristics may be overridden, and redefined, and the client specific code is generated 728 for the display 730. If the element is an unsupported element 732 a runtime error may be returned for the invalid element.

The elements described herein are exemplary and it is contemplated with thin the scope of the embodiments that the processes herein are equally applicable to other elements. Further, one of skill in the art will appreciate that most applications comprise of many elements, for example, stacked on top of one another, or nested within each other. In such instances, multiple processes would occur, in that for each element in the application processing must occur. In such embodiments, the runtime starts at the beginning of the AML document (the root node, as found in all XML documents) and visits each node one by one.

Although the above process is explained in conjunction with following a particular steps, such is not intended to be a limitation on the embodiments of the present invention. It is contemplated within the scope of the embodiments that the process could proceed in an alternative order or the steps could be performed in an alternatively arranged way.

Although the present invention has been particularly described with reference to the preferred embodiments thereof, it should be readily apparent to those of ordinary skill in the art that changes and modifications in the form and details may be made without departing from the spirit and scope of the invention. It is intended that the invention encompass such changes and modifications.

1. A method of defining platform-independent client-server software applications, comprising:
defining an application layout using a pixel-independent layout language;
defining user interface actions within the pixel-independent layout language using a script language; and
dynamically computing the actual application layout depending on client context.

2. The method of claim 1, wherein client context comprises information about the platform on which the client is executing.

3. The method of claim 1, wherein client context comprises information about the user of the application.

4. The method of claim 1, wherein the platform-independent layout language is XML.

5. The method of claim 1, wherein the script language is JavaScript.

6. The method of claim 1, wherein dynamic computing comprises:
using a piece-wise function f(w, h) where w is the width of the client screen in pixels and h is the height of the client screen in pixels.

7. A method for enabling platform agnostic client-server software applications comprising:
processing of an element;
determining an element type;
processing the element according to the element type;
generating a client specific code; and
using the client specific code to display the element on a client specific display.

8. The method of claim 7, wherein the element type is selected from the group comprising, layout, pattern or widget elements.

9. The method of claim 8, wherein the pattern element is at least one of master-detail, column browse, search/results, filter dataset, and palette/canvas.

10. A method for defining platform-independent client-server software applications, comprising:
using an XML namespace definition to dynamically obtain a platform-specific implementation of a platform-independent user interface toolkit;
defining an application layout using a pixel-independent layout language;
defining user interface actions within the pixel-independent layout language using a script language; and
dynamically computing the actual application layout depending on client context.
